(19) United States
(12) Patent Application Publication
(10) Pub. No.: US 2009/0190201 A1
(43) Pub. Date: Jul. 30, 2009

(54) MICROMIRROR DEVICE

(75) Inventor: Satoshi OHARA, Hachioji-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/355,171

(22) Filed: Jan. 16, 2009

(30) Foreign Application Priority Data
Jan. 30, 2008 (JP) 2008-019373

(51) Int. Cl. G02B 26/00

(52) U.S. Cl. 359/290

(57) ABSTRACT

A micromirror device includes a first member, a second member, joining members joining the first and second members, and a spacer placed between the first and second members. The spacer includes a first surface in surface contact with the first member, a second surface parallel to the first surface and in surface contact with the second member, at least one first through hole, and second through holes, the first and second through holes extending between the first and second surfaces. The joining members include at least one first joining member accommodated in the first through hole and second joining members accommodated in the second through holes. The first through hole restrains movement of the first joining member in any direction parallel to the first and second surfaces. The second through holes allow movement of the second joining members in at least one direction parallel to the first and second surfaces.

### CROSS-REFERENCE TO RELATED APPLICATIONS

This application is based upon and claims the benefit of priority from prior Japanese Patent Application No. 2008-019373, filed Jan. 30, 2008, the entire contents of which are incorporated herein by reference.

### BACKGROUND OF THE INVENTION

1. Field of the Invention

The present invention relates to a micromirror device.

2. Description of the Related Art

For example, Jpn. Pat. Appln. KOKAI Publication No. 2005-316043 discloses a micromirror device formed by joining a micromirror chip as the first member to an electrode substrate as the second member with solder bumps. In this micromirror device, the distance between the micromirror chip and the electrode substrate is adjusted to a desired distance by controlling the deformation amounts of the solder bumps at the time of hot fusion in accordance with the support load.

The above micromirror chip includes movable mirror portions, which are connected to a mirror support portion through hinges. The mirror support portion is locally fixed to the electrode substrate with solder bumps. This may cause a “mirror movement fault” that when the movable mirror portions move about the hinges, the mirror support portion deforms due to lack of rigidity to result in undesirable variations in the gap amount between the micromirror chip and the electrode substrate. As a consequence, the micromirror device may not obtain desired mirror driving characteristics.

As countermeasures against this fault, there can be provided a manner of fixing the entire surface of the mirror support portion to the entire surface of the electrode substrate with joining members to compensate for the lack of rigidity of the mirror support portion, a manner of newly placing a spacer in the space between the mirror support portion and the electrode substrate and holding and restraining the mirror support portion and the electrode substrate with the spacer through a large area, and the like.

However, with the structure in which the mirror support portion and the electrode substrate are held and restrained by the spacer through a large area, desired heat reliability may not be obtained due to the differences between the linear expansion coefficient of the mirror support portion and electrode substrate and that of the linear expansion coefficient of the spacer. In the case of a micromirror chip having a large area, in particular, it is sometimes impossible to select, for a spacer, a material having the same linear expansion coefficient as that of a mirror support portion or electrode substrate, because of consideration of processing and accuracy.

### BRIEF SUMMARY OF THE INVENTION

The present invention has been made in consideration of these situations, and an object of the present invention is to provide a micromirror device in which variations in gap amount between the first member and the second member are suppressed, and desired heat reliability is ensured.

A micromirror device according to the present invention includes a first member, a second member, joining members joining the first member to the second member, and a spacer placed between the first member and the second member. The spacer includes a first surface in surface contact with the first member and a second surface in surface contact with the second member, the first surface being parallel to the second surface. The spacer includes through holes accommodating the joining members, the through holes extending between the first surface and the second surface and including at least one first through hole and second through holes. The joining members includes at least one first joining member accommodated in the first through hole and second joining members accommodated in the second through holes. The first through hole restrains movement of the first joining member in any direction parallel to the first and second surfaces. On the other hand, the second through holes allow movement of the second joining members in at least one direction parallel to the first and second surfaces.

According to the present invention, there is provided a micromirror device in which variations in gap amount between the first member and the second member are suppressed, and desired heat reliability is ensured.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view of a micromirror device according to the first embodiment of the present invention;

FIG. 2 is a sectional view taken along a line A-A of the micromirror device shown in FIG. 1;

FIG. 3 is a sectional view taken along a line B-B of the micromirror device shown in FIG. 1;

FIG. 4 is a sectional view taken along a line C-C of the micromirror device shown in FIG. 1;

FIG. 5 is a plan view of a spacer and solder materials shown in FIG. 1;

FIG. 6 is an exploded perspective view of a micromirror device according to the second embodiment of the present invention;

FIG. 7 is a sectional view taken along a line D-D of the micromirror device shown in FIG. 6; and

FIG. 8 is a plan view of a spacer and solder materials shown in FIG. 6.

### DETAILED DESCRIPTION OF THE INVENTION

The embodiments of the present invention will be described below with reference to the views of the accompanying drawing.

### First Embodiment

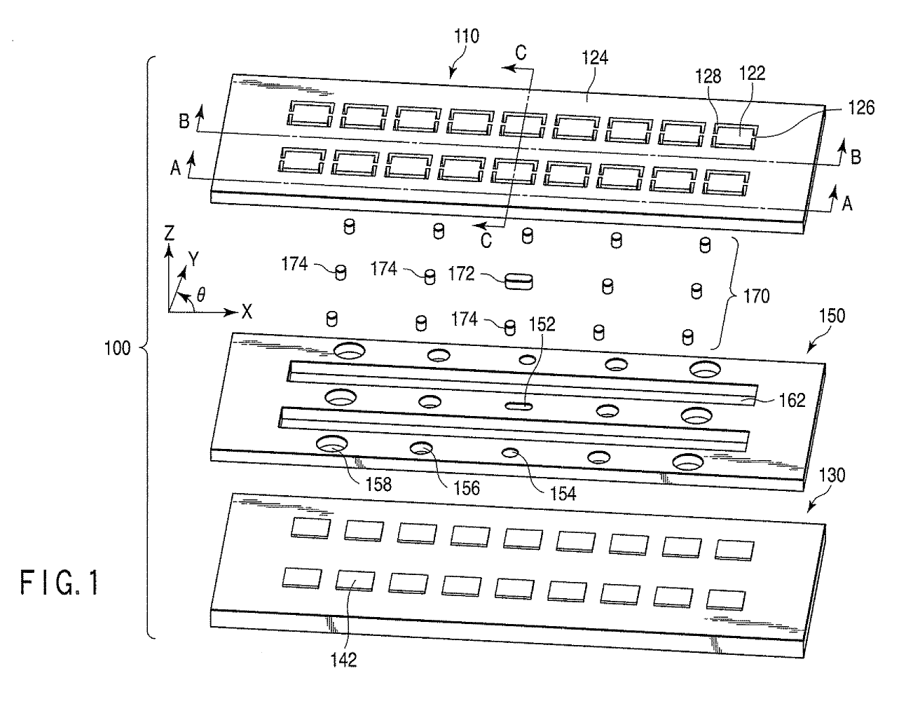

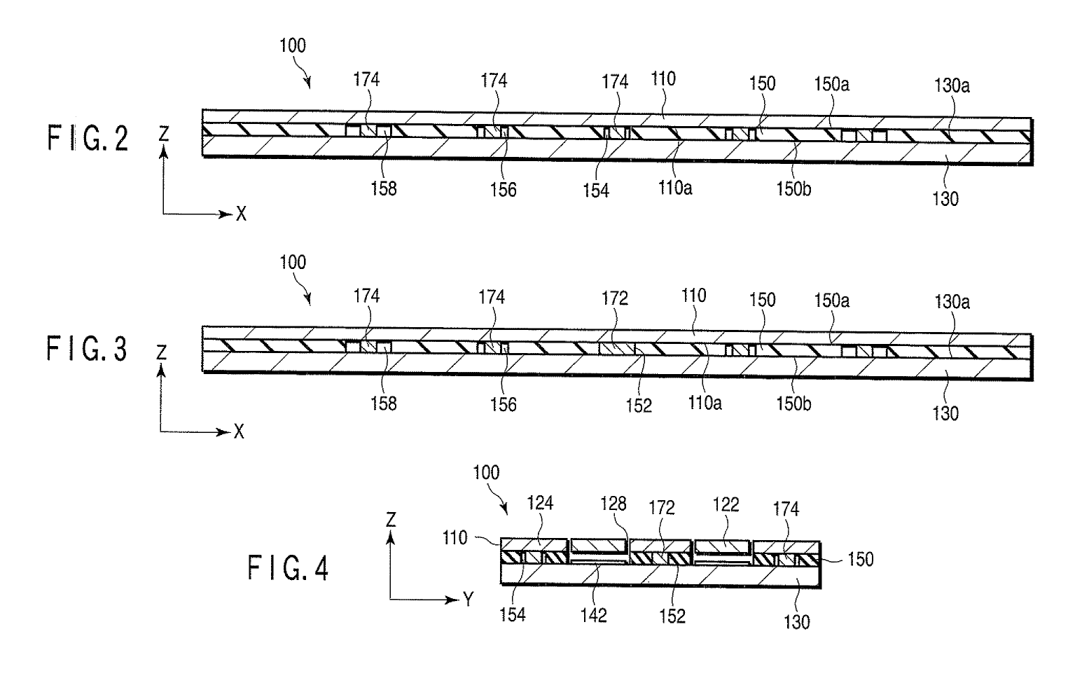

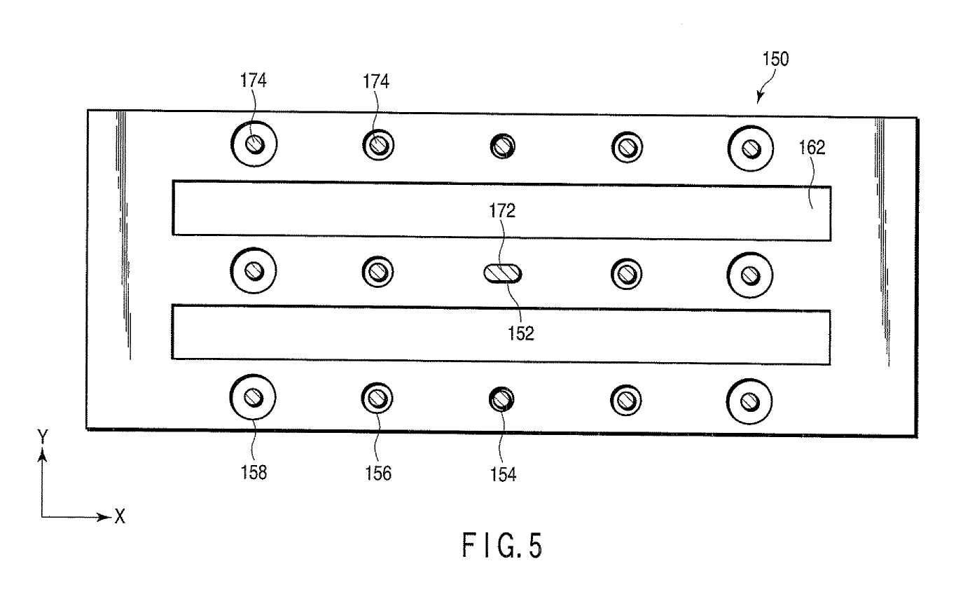

A micromirror device according to the first embodiment of the present invention will be described with reference to FIGS. 1 to 5. FIG. 1 is an exploded perspective view of the micromirror device according to this embodiment. FIG. 2 is a sectional view taken along a line A-A of the micromirror device shown in FIG. 1. FIG. 3 is a sectional view taken along a line B-B of the micromirror device shown in FIG. 1. FIG. 4 is a sectional view taken along a line C-C of the micromirror device shown in FIG. 1. FIG. 5 is a plan view of a spacer and solder materials shown in FIG. 1. In the following description, an orthogonal coordinate system is set as shown in FIG. 1, and the +Z direction and −Z direction of the orthogonal coordinate system shown in FIG. 1 are respectively the upward and downward directions for the sake of convenience.

A micromirror device 100 includes a micromirror chip 110 as the first member, an electrode substrate 130 as the second member, a spacer 150 placed between the micromirror chip 110 and the electrode substrate 130, and solder materials 170 as joining members mechanically and electrically joining the micromirror chip 110 to the electrode substrate 130.

The opposing surfaces of the micromirror chip 110, electrode substrate 130, and spacer 150 are flat. The micromirror chip 110, the electrode substrate 130, and the spacer 150 are in surface contact with each other.

The spacer 150 has an upper flat surface 150a as the first surface in surface contact with a lower surface 110a of the micromirror chip 110 and a lower flat surface 150b as the second surface in surface contact with an upper surface 130a of the electrode substrate 130. The upper flat surface 150a is parallel to the lower flat surface 150b. The distance between the upper flat surface 150a and the lower flat surface 150b is uniform, and is constant regardless of position. That is, the spacer 150 has a uniform thickness.

The spacer 150 has through holes 152, 154, 156, and 158 accommodating the solder materials 170. The through holes 152, 154, 156, and 158 extend through the spacer 150 between the upper flat surface 150a and the lower flat surface 150b.

The micromirror chip 110 includes a mirror support portion 124 having opening portions 128 aligned in two rows, movable mirror portions 122 respectively positioned inside the opening portions 128, and hinge portions 126 connecting the movable mirror portions 122 to the mirror support portion 124. The micromirror chip 110 is formed from, for example, an Si substrate.

The electrode substrate 130 has driving electrodes 142 for electrostatically driving the movable mirror portions 122, respectively, and interconnections for electric connection to the driving electrodes 142. The electrode substrate 130 is formed from, for example, Si, like the micromirror chip 110.

The micromirror chip 110 and the electrode substrate 130 are arranged so that the movable mirror portions 122 respectively face the driving electrodes 142. Each movable mirror portion 122 tilts about the hinge portions 126 as an axis owing to the electrostatic attraction generated between the movable mirror portion 122 and the driving electrode 142.

The spacer 150 has two openings 162 for preventing contact with the movable mirror portions 122 when the movable mirror portions 122 tilt about the hinge portions 126 as axes. Each opening 162 has a shape obtained by integrating the opening portions 128 in each row of the micromirror chip 110 into one. The spacer 150 accordingly has a shape almost the same as that of the mirror support portion 124 of the micromirror chip 110.

The spacer 150 has a uniform thickness corresponding to the distance (gap amount) between the movable mirror portions 122 and the driving electrodes 142. This distance (gap amount) is determined from various conditions such as a driving voltage and the tilt angle required for the movable mirror portions 122. The distance (gap amount) is, for example, approximately 100 μm, although not limited to this.

When a voltage is applied to each driving electrode 142, an electrostatic attraction is generated between the movable mirror portion 122 and the driving electrode 142. The movable mirror portion 122 tilts about the hinge portions 126 as an axis owing to this electrostatic attraction. In this case, since the hinge portions 126 are twisted as the movable mirror portion 122 tilts, stress is generated in the mirror support portion 124. That is, as the movable mirror portions 122 tilt, the mirror support portion 124 receives force through the hinge portions 126. However, the deformation of the mirror support portion 124 in the vertical direction (Z direction) is restrained by the solder materials 170 joining the mirror support portion 124 to the electrode substrate 130 through the through holes 152, 154, 156, and 158 of the spacer 150 and the spacer 150 held between the mirror support portion 124 and the electrode substrate 130. This structure suppresses variations in gap amount even when the movable mirror portions 122 are driven.

In order to obtain a desired tilt angle with high accuracy when the movable mirror portions 122 are driven, very high accuracy is required for the distance between the movable mirror portions 122 and the driving electrodes 142. For this reason, high accuracy is required for the thickness of the spacer 150 that has a great influence on the distance between the movable mirror portions 122 and the driving electrodes 142. For example, the accuracy is 100±1 μm or less, and the material to be used is limited to a material that allows the spacer 150 with the accuracy to be manufactured.

Si is conceivable as the first candidate. However, since Si is a semiconductor, if such a spacer is placed between the micromirror chip 110 and the electrode substrate 130, where electrostatic force is generated as in this embodiment, the spacer may influence the distribution of electrostatic force and the behavior of the movable mirror portions 122. Thus, such a material cannot be used.

Various glass materials are conceivable as the second candidate. A glass material is an insulator, and allows high thickness accuracy by a polishing process. If, however, a glass material is used for the spacer 150, since Si is used for the micromirror chip 110 and the electrode substrate 130, the micromirror chip 110 and the electrode substrate 130 differ in linear expansion coefficient from the spacer 150. Owing to this linear expansion coefficient difference, as the temperature changes, the micromirror chip 110 and the electrode substrate 130 differ in thermal expansion or contraction amount from the spacer 150. As a result, stress is generated in the solder joining portions, and hence sufficient heat reliability cannot be obtained.

Concerning this problem, according to the present invention, devising the shape of each through hole provided in the spacer 150 will provide a structure that can obtain sufficient heat reliability even if the micromirror chip 110 and the electrode substrate 130 differ in linear expansion coefficient from the spacer 150. The through holes of the spacer 150 will be described below.

The through holes 152, 154, 156, and 158 formed in the spacer 150 include one positioning through hole 152 positioned near the middle of the spacer 150 and the remaining through holes 154, 156, and 158. The solder materials 170 include a solder material 172 accommodated in the positioning through hole 152, and solder materials 174 accommodated in the through holes 154, 156, and 158.

The positioning through hole 152 is filled with the solder material 172 without any space between them. In other words, the solder material 172 is fitted in the positioning through hole 152. For this reason, the positioning through hole 152 restrains the movement of the solder material 172 in any direction parallel to the upper flat surface 150a and lower flat surface 150b of the spacer 150. This restrains the translation of the micromirror chip 110 and electrode substrate 130 relative to the spacer 150, around the positioning through hole 152, in a direction parallel to the upper flat surface 150a and lower flat surface 150b of the spacer 150. That is, the movement of the micromirror chip 110 and electrode substrate 130 relative to the spacer 150 is restrained, around the positioning through hole 152, in the X-Y direction.

In addition, the positioning through hole 152 has a sectional shape that is not circular. However, the sectional shape is not limited to this. The positioning through hole 152 has, for example, an almost elliptic sectional shape. Obviously, the sectional shape of the positioning through hole 152 may be a polygonal shape or another arbitrary shape as long as it is not a circular shape. This restrains the rotational movement of the micromirror chip 110 and electrode substrate 130 relative to the spacer 150, around the positioning through hole 152, within a plane parallel to the upper flat surface 150a and lower flat surface 150b of the spacer 150. That is, the movement of the micromirror chip 110 and electrode substrate 130 relative to the spacer 150 in the 0 direction is restrained around the positioning through hole 152.

That is, the movement of the micromirror chip 110 and electrode substrate 130 relative to the spacer 150 in the X-Y-θ direction is restrained around the positioning through hole 152.

On the other hand, the solder materials 174 are accommodated in the through holes 154, 156, and 158 with intervals. That is, the through holes 154, 156, and 158 each have a volume larger than that of each of the solder materials 174, which are accommodated in the respective holes. In other words, the through holes 154, 156, and 158 each have a diameter larger than that of each of the solder materials 174. The through holes 154, 156, and 158 allow the movement of the solder materials 174 in any direction parallel to the upper flat surface 150a and lower flat surface 150b of the spacer 150. This allows the translation of the micromirror chip 110 and electrode substrate 130 relative to the spacer 150 in any direction parallel to the upper flat surface 150a and lower flat surface 150b of the spacer 150 around the through holes 154, 156, and 158. That is, the movement of the micromirror chip 110 and electrode substrate 130 relative to the spacer 150 in the X-Y direction is allowed around the through holes 154, 156, and 158.

Of the through holes 154, 156, and 158, the through hole 154 is positioned nearest to the positioning through hole 152, the through hole 156 is positioned next nearest to the positioning through hole 152, and the through hole 158 is positioned farthest from the positioning through hole 152. The through holes 154, 156, and 158 are arranged to be point-symmetric with reference to the center of the positioning through hole 152. To be precise, the two through holes 154 are point-symmetric with respect to the center of the positioning through hole 152. Of the six through holes 156 and 158, two specific holes are point-symmetric with respect to the center of the positioning through hole 152.

Any two holes of the through holes 154, 156, and 158 that are arranged to be point-symmetric with respect to the center of the positioning through hole 152 have the same sectional shape. For example, the through holes 154, 156, and 158 each have a circular sectional shape. The sections of the through holes 154, 156, and 158 may have any shapes as long as the through holes 154, 156, and 158 accommodate the solder materials 174 with intervals.

In addition, the volumes, in other words, the diameters, of the through holes 154, 156, and 158 gradually increase with an increase in distance from the positioning through hole 152. That is, the through hole 156 has a larger diameter than the through hole 154, and the through holes 158 has a larger diameter than the through hole 156. For this reason, the interval between the through hole 156 and the solder material 174 is larger than that between the through hole 154 and the solder material 174, and the interval between the through hole 158 and the solder material 174 is larger than that between the through hole 156 and the solder material 174. That is, the sectional shapes of the through holes 154, 156, and 158 have shapes having larger intervals from the sectional shapes of the solder materials 174 with an increase in distance between the positioning through hole 152 and the through holes 154, 156, and 158 in a direction of a straight line passing through a center of the positioning through hole 152 and a center of a through hole 154, 156, and 158, for example, along the rows, in which the movable mirror portions 122 are aligned, i.e., the X-axis.

The intervals between the through holes 154, 156, and 158 and the solder materials 174 each are preferably designed to be equivalent to the product of the following three values: (1) the difference between the linear expansion coefficient of the micromirror chip 110 and electrode substrate 130 and that of the spacer 150, (2) a predicted temperature change amount, and (3) a corresponding one of the distances from the positioning through hole 152 to the through holes 154, 156, and 158, so as not to impair the effect of suppressing variations in gap amount at the time of movement of the movable mirror portions 122 described above due to an unnecessary increase in the size of the through holes 154, 156, and 158.

A method of manufacturing the micromirror device 100 according to this embodiment will be described below.

The micromirror chip 110 is mechanically and electrically joined to the electrode substrate 130 with the solder materials 170. Although not shown, mount pads required for joining with the solder materials 170 has been provided beforehand at predetermined positions on the micromirror chip 110 and the electrode substrate 130. Mount pads required for solder joining are, for example, metal films made of Ni, Cu, Au, or the like. Various methods are conceivable for supplying the solder materials 170. Here, solder pumps are formed on mount pads on the electrode substrate 130 before it is joined to the micromirror chip 110. First of all, the spacer 150 is placed on the electrode substrate 130 on which the solder bumps have already been formed. In this state, the electrode substrate 130 and the spacer 150 are aligned at desired positions on the micromirror chip 110. The resultant structure is then pressurized and heated to complete mounting.

As described above, in the micromirror device of this embodiment, the micromirror chip 110 is joined to the electrode substrate 130 with the solder materials 170, with the spacer 150 for suppressing the deformation of the mirror support portion 124 being held between the micromirror chip 110 and the electrode substrate 130.

As described above, the micromirror device 100 of this embodiment is configured such that the micromirror chip 110 and the electrode substrate 130 are arranged in surface contact with the spacer 150 having a uniform thickness, and are joined to each other with the solder materials 170 through the through holes 152, 154, 156, and 158 of the spacer 150. This suppresses the displacement of the mirror support portion 124 in the vertical direction when the movable mirror portions 122 are driven by electrostatic force, thereby preventing a mirror movement fault.

In addition, the micromirror device 100 of this embodiment is configured so that the deformation of the micromirror chip 110 and electrode substrate 130 in the vertical direction, i.e., the Z direction is restrained by the solder materials 172 and 174 and the spacer 150. Furthermore, since the sectional shape of the positioning through hole 152 has a shape other than a circular shape and the solder material 172 is fitted in the positioning through hole 152, the deformation of the micromirror chip 110 and electrode substrate 130 relative to the spacer 150 in the X-Y-θ direction around the positioning through hole 152 is restrained. On the other hand, intervals are provided between the through holes 154, 156, and 158 and the solder materials 174, allowing the movement of the micromirror chip 110 and electrode substrate 130 relative to the spacer 150 in the X-Y direction around the through holes 154, 156, and 158.

With this structure, when the micromirror chip 110 and the electrode substrate 130 differ in thermal expansion/contraction amount from the spacer 150 with a change in temperature, the micromirror chip 110 and the electrode substrate 130 slide on the spacer 150 except for the joint portion with the solder material 172 in the positioning through hole 152, so that no load is applied to the joint portions of the solder materials 174. That is, since the difference in thermal expansion/contraction amount difference between the micromirror chip 110 and the electrode substrate 130 and the spacer 150 is absorbed by the intervals between the through holes 154, 156, and 158 and the solder materials 174, no stress is generated in the joint portions of the solder materials 174. Accordingly, high heat reliability is ensured.

As described above, according to this embodiment, a micromirror device in which a mirror movement fault is prevented and that has high heat reliability is provided.

### Second Embodiment

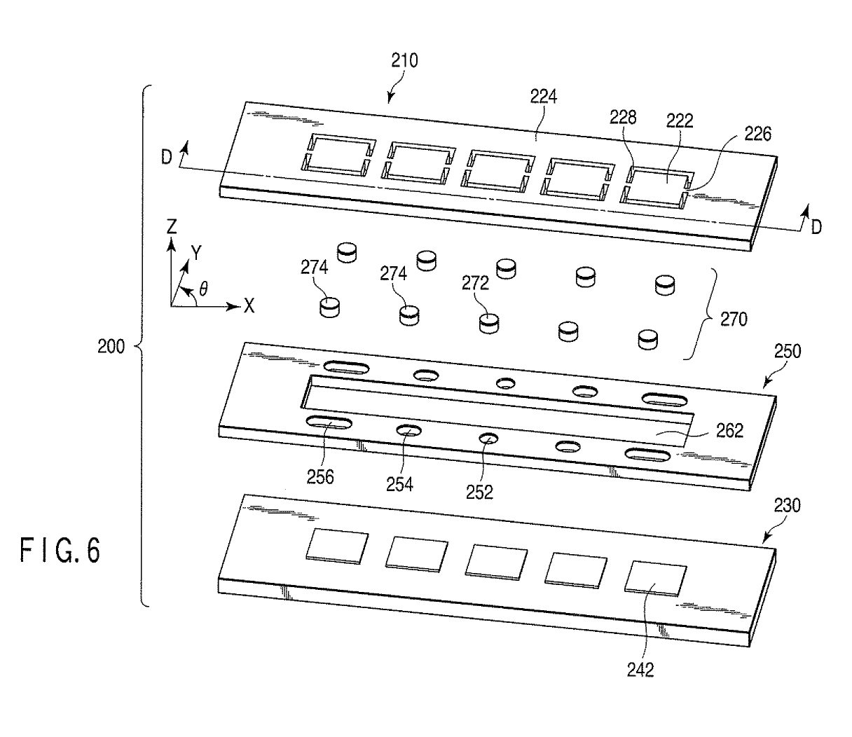

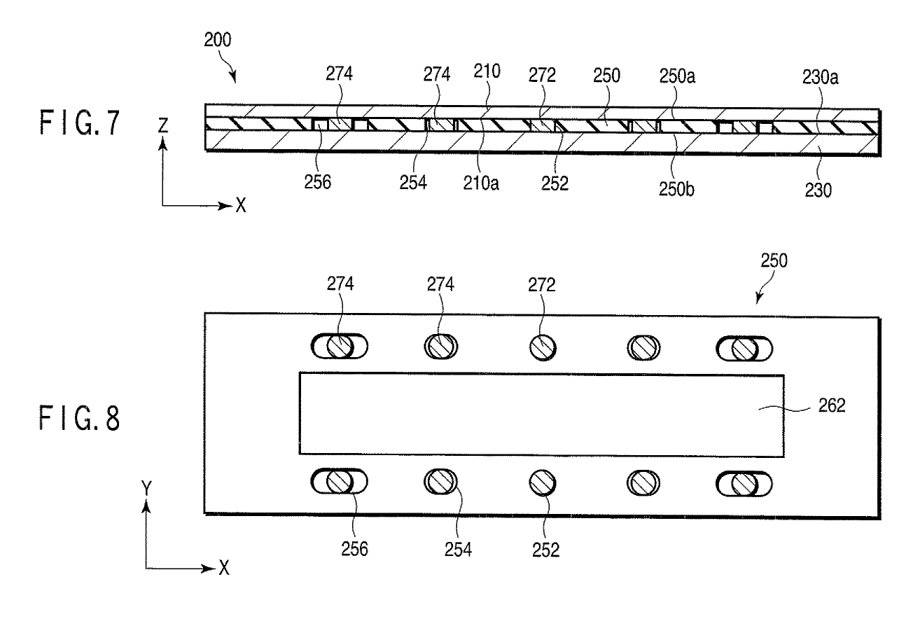

A micromirror device according to the second embodiment of the present invention will be described with reference to FIGS. 6 to 8. FIG. 6 is an exploded perspective view of the micromirror device according to this embodiment. FIG. 7 is a sectional view taken along a line D-D of the micromirror device shown in FIG. 6. FIG. 8 is a plan view of a spacer and solder materials shown in FIG. 6.

A micromirror device 200 includes a micromirror chip 210 as the first member, an electrode substrate 230 as the second members a spacer 250 placed between the micromirror chip 210 and the electrode substrate 230, and solder materials 270 as joining members mechanically and electrically joining the micromirror chip 210 to the electrode substrate 230.

The opposing surfaces of the micromirror chip 210, electrode substrate 230, and spacer 250 are flat. The micromirror chip 210, the electrode substrate 230, and the spacer 250 are in surface contact with each other.

The spacer 250 has an upper flat surface 250a as the first surface in surface contact with a lower surface 210a of the micromirror chip 210 and a lower flat surface 250b as the second surface in surface contact with an upper surface 230a of the electrode substrate 230. The upper flat surface 250a is parallel to the lower flat surface 250b.

The micromirror chip 210 includes a mirror support portion 224 having opening portions 228 aligned in one row, movable mirror portions 222 respectively positioned inside the opening portions 228, and hinge portions 226 connecting the movable mirror portions 222 to the mirror support portion 224.

The electrode substrate 230 has driving electrodes 242 for electrostatically driving the movable mirror portions 222, respectively, and interconnections for electric connection to the driving electrodes 242.

The micromirror chip 210 and the electrode substrate 230 are arranged so that the movable mirror portions 222 respectively face the driving electrodes 242.

The spacer 250 has an opening 262 for preventing contact with the movable mirror portions 222 when the movable mirror portions 222 tilt about the hinge portions 226 as axes. The spacer 250 also has a uniform thickness corresponding to the distance (gap amount) between the movable mirror portions 222 and the driving electrodes 242.

The spacer 250 further includes through holes 252, 254, and 256 accommodating the solder materials 270. The through holes 252, 254, and 256 extend between the upper flat surface 250a and the lower flat surface 250b.

The through holes 252, 254, and 256 include the two positioning through holes 252 and the remaining through holes 254 and 256. The solder materials 270 also include solder materials 272 accommodated in the positioning through holes 252 and solder materials 274 accommodated in the through holes 254 and 256. The number of positioning through holes 252 is not limited to two and may be three or more.

The positioning through holes 252 are aligned in one row. More specifically, the centers of the positioning through holes 252 are positioned on a straight line parallel to the Y-axis. The through holes 254 and 256 are arranged to be line-symmetric with respect to a straight line passing through the centers of the positioning through holes 252. More specifically, the through holes 254 and 256 are arranged to be line-symmetric with respect to a straight line parallel to the Y-axis.

The positioning through holes 252 are filled with the solder materials 272 without any space between them. In other words, the solder materials 272 are fitted in the positioning through holes 252. Consequently, the positioning through hole 252 restrain the movement of the solder materials 272 within a plane parallel to the upper flat surface 250a and lower flat surface 250b of the spacer 250. This restrains the movement of the micromirror chip 210 and electrode substrate 230 relative to the spacer 250 in the X-Y-θ direction around the positioning through holes 252.

On the other hand, the solder materials 274 are accommodated in the through holes 254 and 256 with intervals in the X direction. That is, the size of the through holes 254 and 256 along the Y-axis is equal to the diameter of the solder materials 274, but the size of the through holes 254 and 246 along the X-axis is larger than the diameter of the solder materials 274. For this reason, the through holes 254 and 256 allow the movement of the solder materials 274 in a direction that is parallel to the upper flat surface 250a and lower flat surface 250b of the spacer 250 and perpendicular to a straight line passing through the centers of the positioning through holes 252. More specifically, the through holes 254 and 256 allow the movement of the solder materials 274 in the X direction. This allows the movement of the micromirror chip 210 and electrode substrate 230 relative to the spacer 250 in the X direction around the through holes 254 and 256.

The through holes 254 and 256 that are arranged to be line-symmetric with respect to a straight line passing through the centers of the positioning through holes 252 have the same sectional shape. The through hole 256 is positioned farther from the positioning through hole 252 than the through hole 254. The size of the through hole 256 along the X-axis is larger than that of the through hole 254. Accordingly, the interval between the through hole 256 and the solder material 274 is larger than that between the through hole 254 and the solder material 274. That is, the sectional shapes of the through holes 254 and 256 have shapes having larger intervals from the sectional shapes of the solder materials 274 with an increase in distance between the positioning through holes 252 and the through holes 254 and 256 in a direction of a straight line passing through a center of a positioning through hole 252 and a center of a through hole 254 and 256, for example, along the row, in which the movable mirror portions 222 are aligned, i.e., the X-axis.

The intervals between the through holes 254 and 256 and the solder materials 274 each are preferably designed to be equivalent to the product of the following three values: (1) the difference between the linear expansion coefficient of the micromirror chip 210 and electrode substrate 230 and that of the spacer 250, (2) a predicted temperature change amount, and (3) a corresponding one of the distances from the positioning through hole 252 to the through holes 254 and 256, so as not to impair the effect of suppressing variations in gap amount at the time of movement of the movable mirror portions 222 described above due to unnecessary increases in the sizes of the through holes 254 and 256.

As in the first embodiment, the micromirror device 200 of the second embodiment is configured such that the micromirror chip 210 and the electrode substrate 230 are arranged in surface contact with the spacer 250 having a uniform thickness, and are joined to each other with the solder materials 270 through the through holes 252, 254, and 256 of the spacer 250. This suppresses the displacement of the mirror support portion 224 in the vertical direction when the movable mirror portions 222 are driven by electrostatic force, thereby preventing a mirror movement fault.

In addition, the micromirror device 200 of this embodiment is configured so that the deformation of the micromirror chip 210 and electrode substrate 230 in the vertical direction, i.e., the Z direction is restrained by the solder materials 272 and 274 and the spacer 250. Furthermore, since the spacer 250 has the two positioning through holes 252 and the solder materials 272 are fitted in the positioning through holes 252, the deformation of the micromirror chip 210 and electrode substrate 230 relative to the spacer 250 in the X-Y-θ directions around the positioning through hole 252 is restrained. On the other hand, the intervals are provided between the through holes 254 and 256 and the solder materials 274, allowing the movement of the micromirror chip 210 and electrode substrate 230 relative to the spacer 250 in the X direction around the through holes 254 and 256.

With this structure, when the micromirror chip 210 and the electrode substrate 230 differ in thermal expansion/contraction amount from the spacer 250 with a change in temperature, the micromirror chip 210 and the electrode substrate 230 slide on the spacer 250 except for the joint portions with the solder materials 272 in the positioning through holes 252, so that no load is applied to the joint portions of the solder materials 274. Accordingly, high heat reliability is ensured.

As described above, according to this embodiment, a micromirror device in which a mirror movement fault is prevented and that has high heat reliability is provided.

According to the micromirror device 200 of this embodiment, it is thought from the shape of the micromirror chip 210 that the difference in thermal expansion/contraction amount in the X direction is, in particular, large, and the difference in thermal expansion/contraction amount in the Y direction has almost no influence on the heat reliability.

According to the micromirror device 200 of this embodiment, in particular, the intervals between the through holes 254 and 256 of the spacer 250 and the solder materials 274 are limited to the X direction in which the effect of improving heat reliability is high to increase the contact area between the mirror support portion 224 and the spacer 250. This improves the controllability of variations in gap amount at the time of movement of the movable mirror portions 222.

Although the embodiments of the present invention have been described with reference to the views of the accompanying drawing, the present invention is not limited to these embodiments. The embodiments can be variously modified and changed within the spirit and scope of the invention.

For example, in the first and second embodiments, the positioning through hole(s) is provided near the center of the spacer. However, almost the same advantages are obtained even if the positioning through hole(s) is provided in other portion(s). In addition, in the first and second embodiments, the through holes other than the positioning through hole(s) are symmetrically arranged in the X and Y directions. However, the through holes may be asymmetrically arranged depending on the shape of a micromirror chip, the layout of a wiring board, and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A micromirror device comprising:
a first member;
a second member;
joining members joining the first member to the second member; and
a spacer placed between the first member and the second member,
the spacer including a first surface in surface contact with the first member and a second surface in surface contact with the second member, the first surface being parallel to the second surface, the spacer including through holes accommodating the joining members, and the through holes extending between the first surface and the second surface and including at least one first through hole and second through holes,
the joining members including at least one first joining member accommodated in the first through hole and second joining members accommodated in the second through holes,
the first through hole restraining movement of the first joining member in any direction parallel to the first and second surfaces, and
the second through holes allowing movement of the second joining members in at least one direction parallel to the first and second surfaces.

2. The device according to claim 1, wherein
the first substrate comprises a micromirror chip including at least one movable mirror portion and a mirror support portion supporting the movable mirror portion, and
the second substrate comprises an electrode substrate including a driving electrode to drive the movable mirror portion.

3. The device according to claim 2, wherein the micromirror chip includes movable mirror portions aligned in at least one row.

4. The device according to claim 3, wherein the micromirror chip includes movable mirror portions aligned in rows.

5. The device according to claim 1, wherein the spacer includes only one first through hole, the first through hole having a sectional shape other than a circular shape.

6. The device according to claim 5, wherein the second through holes are arranged to be point-symmetric with respect to a center of the first through hole.

7. The device according to claim 6, wherein any two second through holes that are arranged to be point-symmetric with respect to the center of the first through hole have the same sectional shape.

8. The device according to claim 5, wherein the second through holes allow movement of the second joining members in any direction parallel to the first and second surfaces.

9. The device according to claim 1, wherein the spacer includes first through holes aligned in one row, and the second through holes are arranged to be line-symmetric with respect to a straight line passing through a center of the first through hole.

10. The device according to claim 9, wherein any second through holes that are arranged to be line-symmetric with respect to the straight line passing through the center of the first through hole have the same sectional shape.

11. The device according to claim 9, wherein the second through holes allow movement of the second joining members in a direction that is parallel to the first and second surfaces and perpendicular to a straight line passing through centers of the first through holes.

12. The device according to claim 7, wherein sectional shapes of the second through holes have shapes having larger intervals from sectional shapes of the second joining members with an increase in distance between the first through hole and the second through holes in a direction of a straight line passing through a center of a first through hole and a center of a second through hole.

13. The device according to claim 10, wherein sectional shapes of the second through holes have shapes having larger intervals from sectional shapes of the second joining members with an increase in distance between the first through holes and the second through holes in a direction of a straight line passing through a center of a first through hole and a center of a second through hole.
